(19) United States
(12) Patent Application Publication
(10) Pub. No.: US 2014/0046845 A1
(43) Pub. Date: Feb. 13, 2014

(54) METHOD AND SYSTEM FOR A PAYMENT PROCESS TO REDUCE FRAUD

(71) Applicants: Jennifer R. Dogin, Mamaroneck, NY (US); Shoshana Rosenfield, Rye, NY (US); Brian Maw, Norwalk, CT (US)

(72) Inventors: Jennifer R. Dogin, Mamaroneck, NY (US); Shoshana Rosenfield, Rye, NY (US); Brian Maw, Norwalk, CT (US)

(73) Assignee: MASTERCARD INTERNATIONAL INCORPORATED, Purchase, NY (US)

(21) Appl. No.: 13/571,401

(22) Filed: Aug. 10, 2012

(51) Int. Cl. G06Q 20/40; G06Q 20/22

(52) U.S. Cl. 705/44; 705/39

(57) ABSTRACT

A method for processing a reservation includes: receiving reservation information, the information including a consumer identifier, merchant identifier, payment information, and a date and/or time; storing the information; transmitting the consumer identifier and the date and/or time to a merchant associated with the merchant identifier; identifying fulfillment of the reservation; and transmitting the information for payment of a transaction. A method for processing a financial transaction includes: receiving transaction information for a financial transaction to be processed, the information including a consumer identifier, merchant identifier, payment information, and an expected date and/or time of the financial transaction; storing the information; receiving an authorization request for the financial transaction, the request including the consumer identifier, the merchant identifier, a received date and/or time, and a transaction amount; and processing the transaction using the information if the received date and/or time is temporally proximal to the expected date and/or time.

### FIELD

The present disclosure relates to a payment process which reduces fraud, specifically, reducing fraud in transactions resulting from a reservation by providing payment details prior to the fulfillment of the reservation.

### BACKGROUND

When consumers engage in financial transactions with merchants in person, it may leave both parties at risk for fraud. The merchant, when accepting a payment card, may be accepting the payment card from a party presenting it fraudulently, such as a person who has stolen the identity of the card owner. Such fraud may leave the merchant at risk for having the transaction stopped after the fact by the card owner or issuer, once the merchant has already provided goods or services to the perpetrator of the fraud. These types of fraudulent transactions can result in a loss of revenue for both the merchant and also for employees in the service industry whose tips may be at risk.

In such in-person transactions, consumers may also be at risk, especially if the consumer temporarily relinquishes possession of their payment card. For example, especially in the food service industry, it is normal practice for a consumer to provide a payment card to an employee, who then keeps possession of the card for anywhere from a few seconds to several minutes. This places the card at risk to be stolen or its details copied, which may result in the theft of the identity of the cardholder, or the use of the card in a number of fraudulent transactions. Such fraud may not only hurt the consumer, but also subsequent merchants who are taken advantage of by the perpetrator of the fraud.

Some methods have been developed that allow for consumers to engage in financial transactions without giving up possession of their payment card, such as PayPass® from MasterCard, which uses near field communication to transmit payment details to a point-of-sale device. While such methods may allow a consumer to retain possession of their payment card, they may still leave the card vulnerable for fraud. Card details may still be visible, or may be captured via a hidden near field communication device placed within close proximity of the point-of-sale device.

Thus, there is a need for a system and method for processing payment to reduce fraud, specifically by allowing for payment details to be provided to a merchant without the need for a consumer to physically present their payment card in an in-person transaction.

### SUMMARY

The present disclosure provides a description of a systems and methods for processing a reservation, processing a financial transaction, and approving a financial transaction

A method for processing a reservation includes: receiving, by a receiving device, reservation information for a reservation, wherein the reservation information includes at least a consumer identifier, a merchant identifier, payment information, and a date and/or time; storing, in a database, the received reservation information; transmitting, by a transmitting device, at least the consumer identifier and the date and/or time to a merchant associated with the merchant identifier; identifying, by a processing device, fulfillment of the reservation; and transmitting, by the transmitting device, the stored payment information for payment of a financial transaction.

A method for processing a financial transaction includes: receiving, by a receiving device, transaction information for a financial transaction to be processed, wherein the transaction information includes at least a consumer identifier, a merchant identifier, payment information, and an expected date and/or time of the financial transaction; storing, in a database, the received transaction information; receiving an authorization request for the financial transaction, wherein the authorization request includes at least the consumer identifier, the merchant identifier, a received date and/or time, and a transaction amount; and processing, by a processing device, the financial transaction using the stored payment information if the received date and/or time is temporally proximal to the expected date and/or time.

A method for approving a financial transaction includes: transmitting, by a transmitter of a mobile communication device, transaction information for a financial transaction to be processed, wherein the transaction information includes at least a consumer identifier, a merchant identifier, payment information, and a date and/or time; receiving, temporally proximal to the date and/or time, by a receiver of the mobile communication device, transaction details for the financial transaction, wherein the transaction details includes at least a transaction amount; and transmitting, by the transmitter, an approval message approving the financial transaction.

A system for processing a reservation includes a receiver, a database, a transmitter, and a processor. The receiver is configured to receive reservation information for a reservation, wherein the reservation information includes at least a consumer identifier, a merchant identifier, payment information, and a date and/or time. The database is configured to store the received reservation information. The transmitter is configured to transmit at least the consumer identifier and the date and/or time to a merchant associated with the merchant identifier. The processor is configured to identify fulfillment of the reservation and cause the transmitter to transmit the stored payment information for payment of a financial transaction.

A system for processing a financial transaction includes a receiver, a database, and a processor. The receiver is configured to receive transaction information for a financial transaction to be processed, wherein the transaction information includes at least a consumer identifier, a merchant identifier, payment information, and an expected date and/or time of the financial transaction, and receive an authorization request for the financial transaction, wherein the authorization request includes at least the consumer identifier, the merchant identifier, a received date and/or time, and a transaction amount. The database is configured to store the received transaction information. The processor is configured to process the financial transaction using the stored payment information if the received date and/or time are temporally proximal to the expected date and/or time.

A mobile communication device for approving a financial transaction includes a transmitter and a receiver. The transmitter is configured to transmit transaction information for a financial transaction to be processed, wherein the transaction information includes at least a consumer identifier, a merchant identifier, payment information, and a date and/or time. The receiver is configured to receive, temporally proximal to the date and/or time, transaction details for the financial transaction, wherein the transaction details includes at least a transaction amount. The transmitter is further configured to transmit an approval message approving the financial transaction.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for reducing fraud in the process of payments in accordance with exemplary embodiments.

FIG. 2 is a block diagram illustrating a processing server in accordance with exemplary embodiments.

FIG. 3 is a block diagram illustrating a reservation server in accordance with exemplary embodiments.

FIG. 4 is a block diagram illustrating a mobile device in accordance with exemplary embodiments.

FIG. 5 is a block diagram illustrating a reservation data set in accordance with exemplary embodiments.

FIGS. 6A-6D are diagrams illustrating a graphical user interface for processing a reservation and approving a financial transaction using the system of FIG. 1 in accordance with exemplary embodiments.

FIG. 7 is a processing flow illustrating a method for processing a reservation in accordance with exemplary embodiments.

FIGS. 8A and 8B are a processing flow illustrating a method for processing a financial transaction in accordance with exemplary embodiments.

FIG. 9 is a block diagram illustrating system architecture of a computer system in accordance with exemplary embodiments.

FIG. 10 is a flow chart illustrating an exemplary method for processing a reservation in accordance with exemplary embodiments.

FIG. 11 is a flow chart illustrating an exemplary method for processing a financial transaction in accordance with exemplary embodiments.

FIG. 12 is a flow chart illustrating an exemplary method for approving a financial transaction in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Processing a Reservation and Financial Transaction

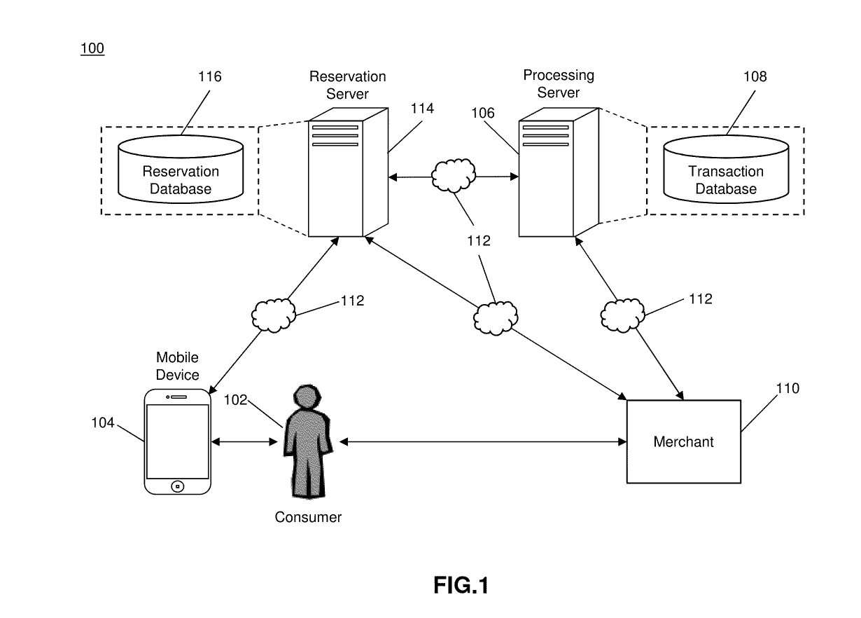

FIG. 1 illustrates a system 100 for processing a reservation and approving and processing a financial transaction. Several of the components of the system 100 may communicate via a network 112. The network 112 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. It may be either public, private or combinations thereof, and might be part of a pre-existing financial transaction processing network. Other suitable network types and configurations will be apparent to persons having skill in the relevant art.

The system 100 may include a consumer 102. The consumer 102 may use a mobile device 104 to make a reservation. The reservation may be a reservation for which there will be a future financial transaction, such as a reservation for the future rendering of goods or services. For example, the reservation may be with a restaurant for dinner, with a spa for a massage, with a rental car company for a car, etc. The mobile device 104 may be any mobile device configured to perform the functions as disclosed herein, such as a mobile phone, smart phone, tablet computer, laptop computer, etc., but should be understood to mean that different devices can be employed for different steps (e.g., a desktop computer to make a reservation, and a mobile device for authenticating the person at the merchant to fulfill the reservation and/or authorize payment), and generally include any other suitable device capable of communicating with the various servers and computers mentioned herein.

The consumer 102 may input reservation details on the mobile device 104, which may submit the details as a reservation to a reservation server 114. The reservation details may include at least a consumer identifier, merchant identifier, an expected date and/or time, and payment information, as discussed in more detail below. The reservation server 114 may receive the reservation details and store them in a reservation database 116. The reservation server 114 may also (e.g., via the network 112) transmit at least the consumer identifier and date and/or time to a merchant 110 (e.g., corresponding to the received merchant identifier). In some embodiments, the reservation server 114 may also transmit the reservation information to the processing server 106. The processing server 106 may be a server configured to process financial transactions.

The consumer 102 may fulfill the reservation with the merchant 110, such as by showing up at a physical location of the merchant 110 at the reserved date and/or time. The merchant 110 may confirm that the consumer 102 corresponds to the reservation using such methods as will be apparent to persons having skill in the relevant art, also discussed in more detail below. The merchant 110 may then provide the consumer 102 with the reserved goods or services and conduct a financial transaction for the provided goods or services.

In one embodiment, the merchant 102 may notify the reservation server 114 of the fulfillment of the reservation by the consumer 102 and/or the processing of the financial transaction. The reservation server 114 may transmit the payment information corresponding to the reservation stored in the reservation database 116 to the merchant 110, who may then submit an authorization request for the financial transaction including the payment information to the processing server 106 for processing.

In an alternative embodiment, the merchant 102 may submit an authorization request to the processing server 106. The processing server 106 may request (e.g., upon receipt of the authorization request) or may have previously received (e.g., and stored in a transaction database 108) reservation information corresponding to the reservation made by the consumer 102. The processing server 106 may process the financial transaction using payment information included in the reservation information and may, once the transaction has been processed, transmit a response to the authorization request to the merchant 110. The merchant 110 may then finalize the transaction with the consumer 102.

It will be apparent to persons having skill in the relevant art that the processing server 106 and the reservation server 114 may be a single server configured to perform the functions of both as discussed herein.

### Processing Server

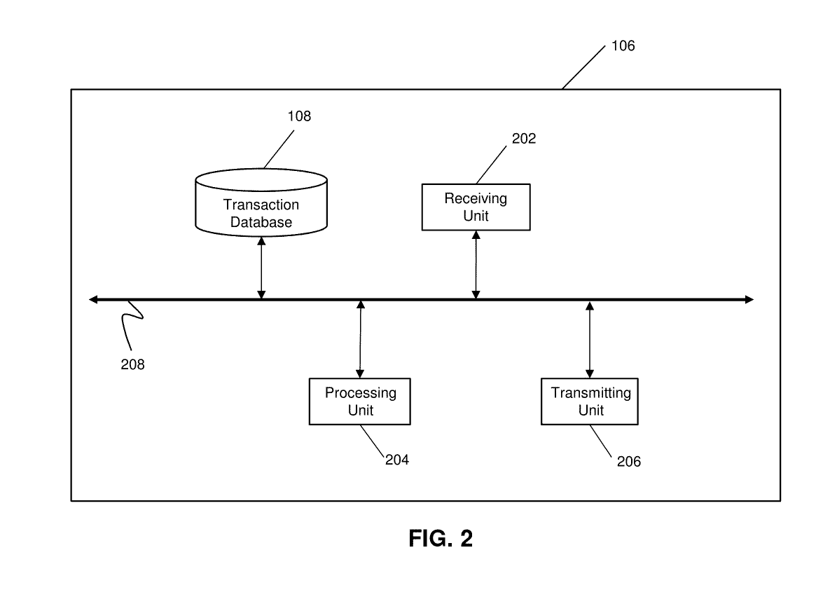

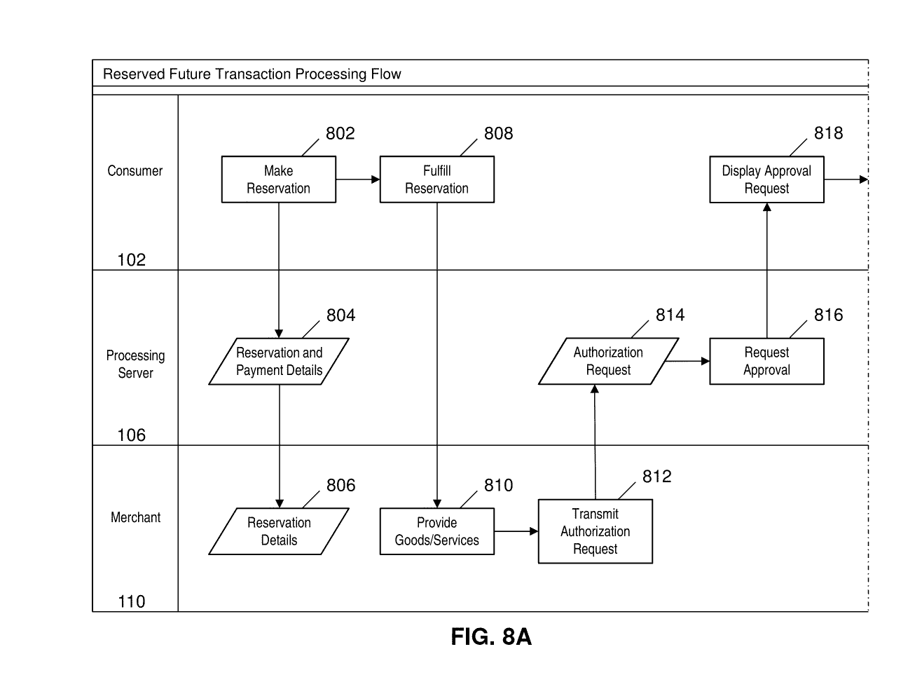

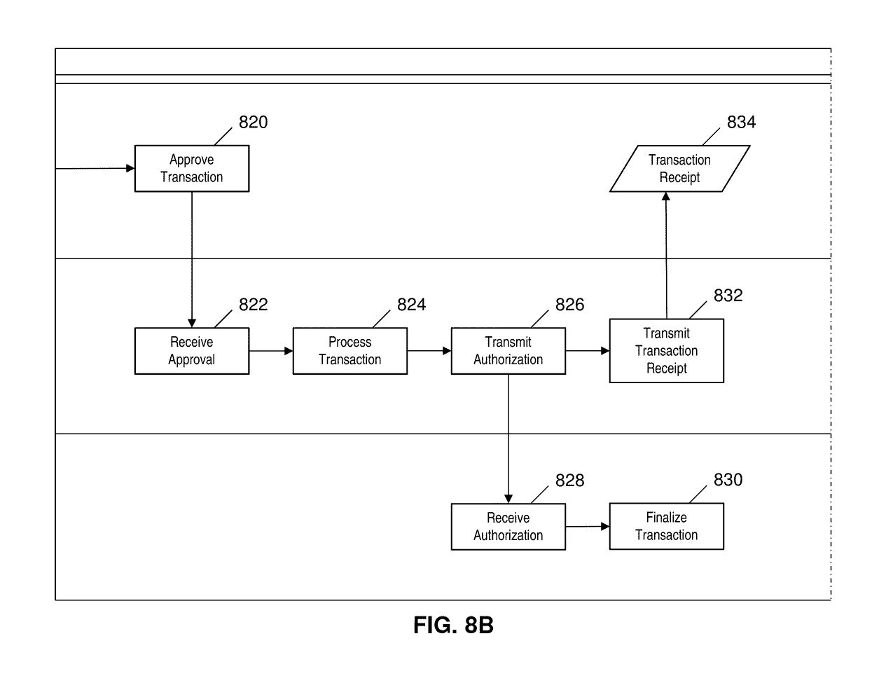

FIG. 2 illustrates an embodiment of the processing server 106. The processing server 106 may be any kind of server configured to perform the functions as disclosed herein, such as the computer system illustrated in FIG. 8 and described in more detail below. The processing server 106 may include the transaction database 108, a receiving unit 202, a processing unit 204, and a transmitting unit 206. Each of the components may be connected via a bus 208. Suitable types and configurations of the bus 208 will be apparent to persons having skill in the relevant art.

The transaction database 108 may be configured to store transaction information for a financial transaction to be processed, such as a financial transaction between the consumer 102 and the merchant 110 corresponding to a previously made reservation. The transaction information may include at least a consumer identifier, a merchant identifier, payment information, and an expected date and/or time of the financial transaction to be processed. The consumer and merchant identifiers may be any value unique to the corresponding consumer or merchant, such as an account number, etc.

The receiving unit 202 may be configured to receive (e.g., from the reservation server 114) the transaction information to be stored in the transaction database 108. The receiving unit 202 may be further configured to receive (e.g., from the merchant 110) an authorization request for a financial transaction, the authorization request including a consumer identifier, merchant identifier, a received date and/or time, and a transaction amount.

The processing unit 204 may be configured to identify if the information included in the received authorization request corresponds to the information stored in the transaction database 108. If the information matches, that is to say if the consumer identifiers and merchant identifiers correspond with one another and the received date and/or time is temporally proximal to the expected date and/or time, then the processing unit 204 may process the financial transaction using the payment information stored in the corresponding data entry in the transaction database 108. Because the payment information is already received by the processing server 106 prior to the transaction at the merchant 110, the consumer 102 may not need to present their payment card to the merchant 110 in order to pay for the transaction. The financial transaction may be processed using a traditional four party system. Suitable methods for processing a financial transaction will be apparent to persons having skill in the relevant art.

The transmitting unit 206 may be configured to transmit a response to the authorization request (e.g., to the merchant 110) once the transaction has been processed. In some embodiments, the transmitting unit 206 may be configured to transmit (e.g., to the mobile device 104) transaction information including at least a transaction amount. The receiving unit 202 may be configured to receive an approval message from the mobile device 104 approving the transaction prior to processing by the processing unit 204. In a further embodiment, the approval message may include an additional amount (e.g., a gratuity) to be added to the transaction amount prior to processing.

Transactions that are considered “temporally proximal” to an expected date and/or time as used herein may be different depending on the circumstance and application. For example, if the reservation were for a dinner and made at a specific time, such as 8:00 p.m., in order for the received authorization request to correspond, the received date and/or time may need to be within two hours of the reserved time. However, if the reservation were for a rental car or a hotel, the received date and/or time may be any time from the start of the reservation up until the return or check out time, or may be within a time period at or around the return or check out time.

### Reservation Server

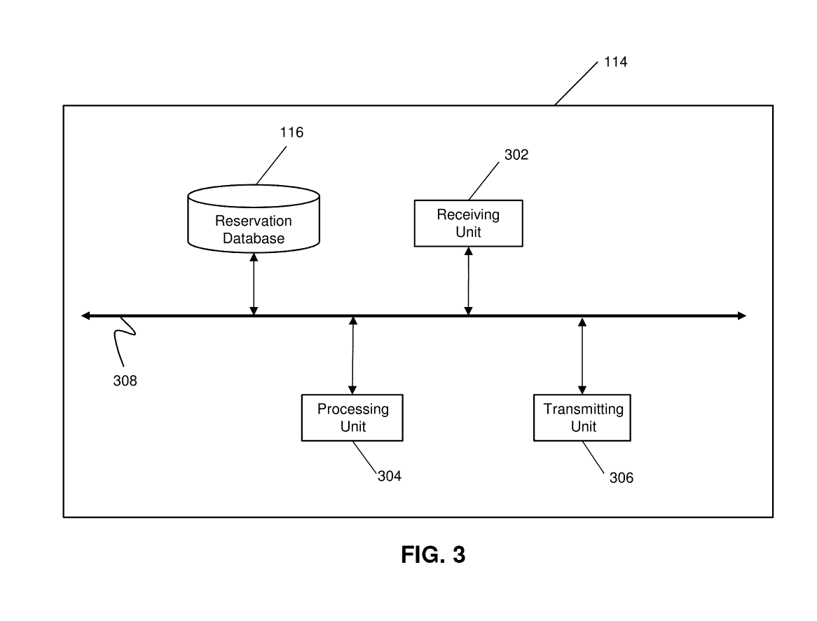

FIG. 3 illustrates an embodiment of the reservation server 114. The reservation sever 114 may include the reservation database 116, a receiving unit 302, a processing unit 304, and a transmitting unit 306. The components may be connected via a bus 308. Suitable types and configurations of the bus 308 will be apparent to persons having skill in the relevant art.

The receiving unit 302 may be configured to receive (e.g., from the mobile device 104) reservation information for a reservation. The reservation information may include at least a consumer identifier, a merchant identifier, payment information, and a date and/or time. The processing unit 304 may be configured to store the received reservation information in the reservation database 116. The transmitting unit 306 may be configured to transmit at least the consumer identifier and the date and/or time to a merchant (e.g., the merchant 110) corresponding to the merchant identifier. In some embodiments, the transmitting unit 306 may also be configured to transmit the reservation information to the processing server 106 (e.g., for storage in the transaction database 108).

The processing unit 304 may also be configured to identify fulfillment of the reservation. In some embodiments, fulfillment of the reservation may be identified by receiving an indication of fulfillment from the merchant 110. In other embodiments, fulfillment of the reservation may be identified by receiving an indication from the mobile device 104. For example, the mobile device 104 may read a machine readable code displayed at the merchant 110, which may indicate to the processing unit 304 of the reservation server 114 that the consumer 102 is at the merchant 110 at or near the reserved date and/or time. Other methods for identifying fulfillment of a reservation are discussed in more detail below and will be apparent to persons having skill in the relevant art.

The transmitting unit 306 may be further configured to transmit, once the reservation has been fulfilled, the stored payment information for payment of a financial transaction. In an exemplary embodiment, the stored payment information may be transmitted to a financial transaction processing agency (e.g., MasterCard®, VISA®, etc.). In such an embodiment, the merchant 110 may never be in possession of payment information or a payment card belonging to the consumer 102, which may result in additional security and efficiency in conducting in-person transactions.

### Mobile Device

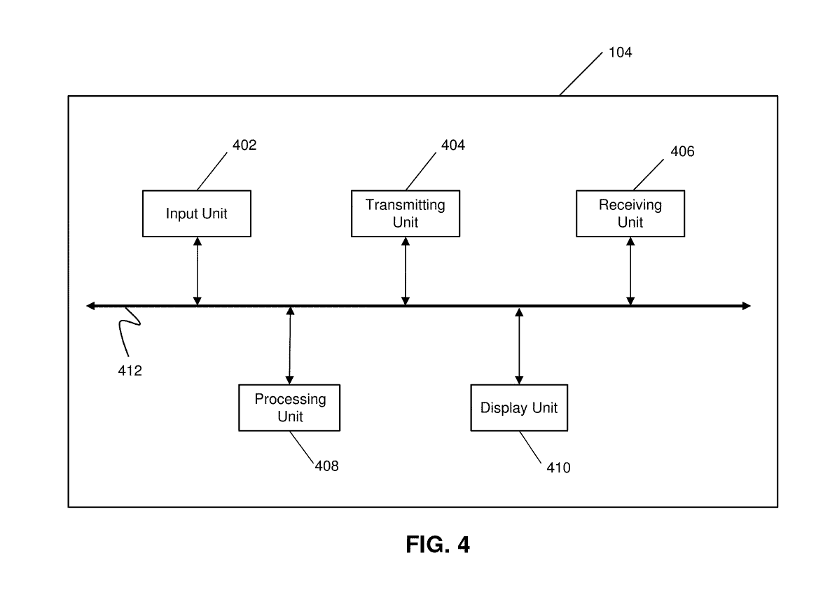

FIG. 4 illustrates an embodiment of the mobile device 104. The mobile device 104 may include an input unit 402, a transmitting unit 404, a receiving unit 406, a processing unit 408, and a display unit 410. Each component may be connected via a bus 412. Suitable types and configurations of the bus 412 will be apparent to persons having skill in the relevant art.

The input unit 402 may be configured to receive input from a user (e.g., the consumer 102) of the mobile device 104. The input unit may be any type of input suitable for performing the functions as disclosed herein, such as a keyboard, a mouse, a touch display (e.g., a capacitive touch display), etc. The input unit 402 may receive input of reservation information, which may include a merchant identifier, payment information, and a date and/or time. The transmitting unit 404 may be configured to transmit the input reservation information (e.g., to the reservation server 114).

The receiving unit 406 may be configured to receive notifications from the reservation server 114. Notifications may include messages confirming or rejecting the attempted reservation, reminders regarding reservations, confirmations of payment, receipts, etc. The receiving unit 406 may also be configured to receive, temporally proximal to the reserved date and/or time, transaction details for a financial transaction corresponding to the reservation. The transaction details may include at least a transaction amount.

The processing unit 408 may be configured to identify the received transaction details and may cause a display unit 410 to display to the consumer 102 the transaction details. An exemplary display of transaction details is discussed in more detail below. The display unit 410 may be any type of display suitable for performing the functions as disclosed herein. For example, the display unit 410 may be a liquid crystal display (LCD), a light emitting diode (LED) display, a capacitive touch display, etc. The input unit 402 may be further configured to receive an indication of approval of the transaction. Then, the processing unit 408 may cause the transmitting unit 404 to transmit an approval message (e.g., to the processing server 106). In one embodiment, the input unit 402 may be configured to receive additional input prior to transmitting an approval, such as authentication information (e.g., a personal identification number (PIN), etc.) or amount information (e.g., tip, gratuity, etc.).

### Reservation Data Set

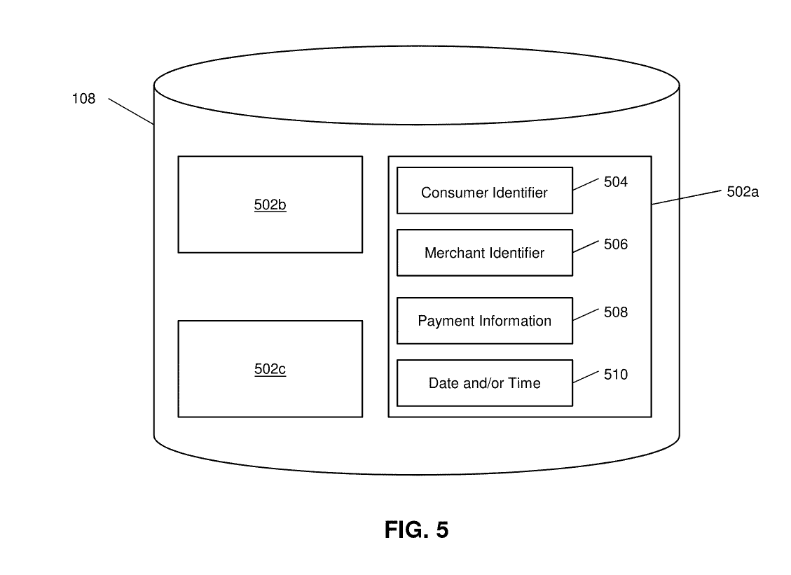

FIG. 5 illustrates data stored in the transaction database 108 or reservation database 116. Data stored in the transaction database 108 or reservation database 116 (the “databases”) may be stored on any type of suitable computer readable media, such as optical storage (e.g., a compact disc, digital versatile disc, blu-ray disc, etc.) or magnetic tape storage (e.g., a hard disk drive). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 112).

The transaction database 108 may include a plurality of reservation datasets 502a, 502b, and 502c. Each reservation dataset 502 may include at least a consumer identifier 504, a merchant identifier 506, payment information 508, and an expected date and/or time 510.

The consumer identifier 504 may be any unique value corresponding to a consumer (e.g., the consumer 102). For example, the consumer identifier 504 may an account number, an e-mail address, a media access control (MAC) address (e.g., of the associated mobile device 104), a username, a personal identification number (PIN), etc. The merchant identifier 506 may be any unique value corresponding to a merchant (e.g., the merchant 110). For example, the merchant identifier 506 may be a merchant identification number (MID), an e-mail address, a MAC address (e.g., of a point-of-sale at a particular location), username, etc.

The payment information 508 may include information that may be used for the payment of the associated financial transaction. Information suitable to serve as the payment information 508 will be apparent to persons having skill in the relevant art and may include payment card numbers, account and routing numbers, gift card numbers, etc. The expected date and/or time 510 may be a date and/or time for which the corresponding reservation is made. It will be apparent to persons having skill in the relevant art that the specificity of the date and/or time may depend on the application and the circumstances of the reservation. For example, a dinner reservation or reservation for personal services (e.g., a haircut, manicure, massage, etc.) may have an expected date and/or time 510 specifying a day, hour, and even minute, whereas a reservation for a hotel or rental car may have an expected date and/or time 510 specifying only a date or a date with a range of times.

### Exemplary Graphical User Interface of the Mobile Device

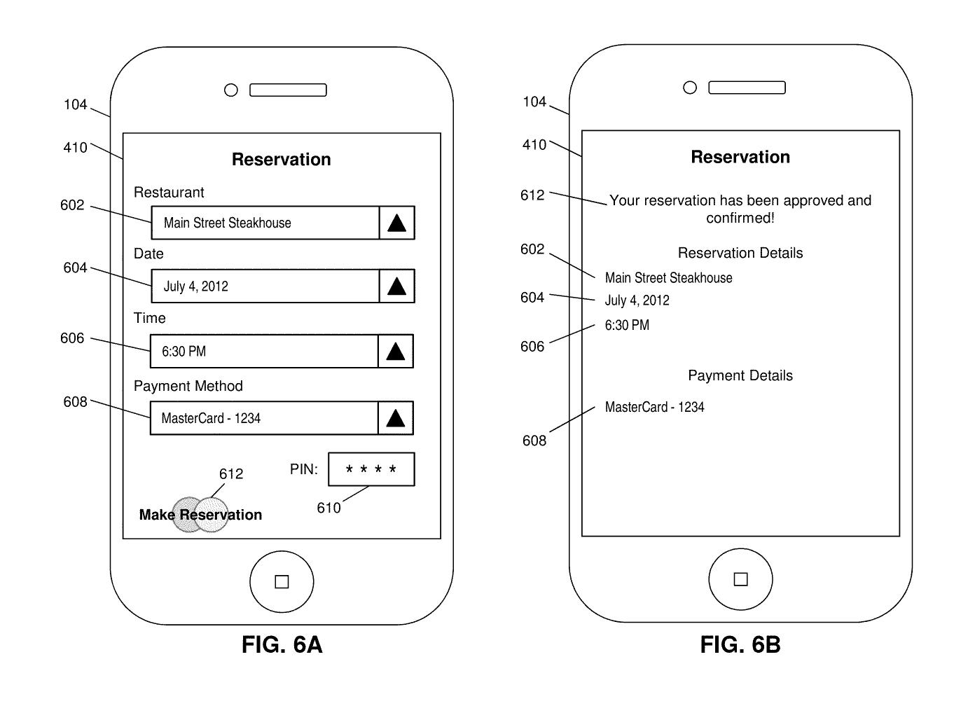

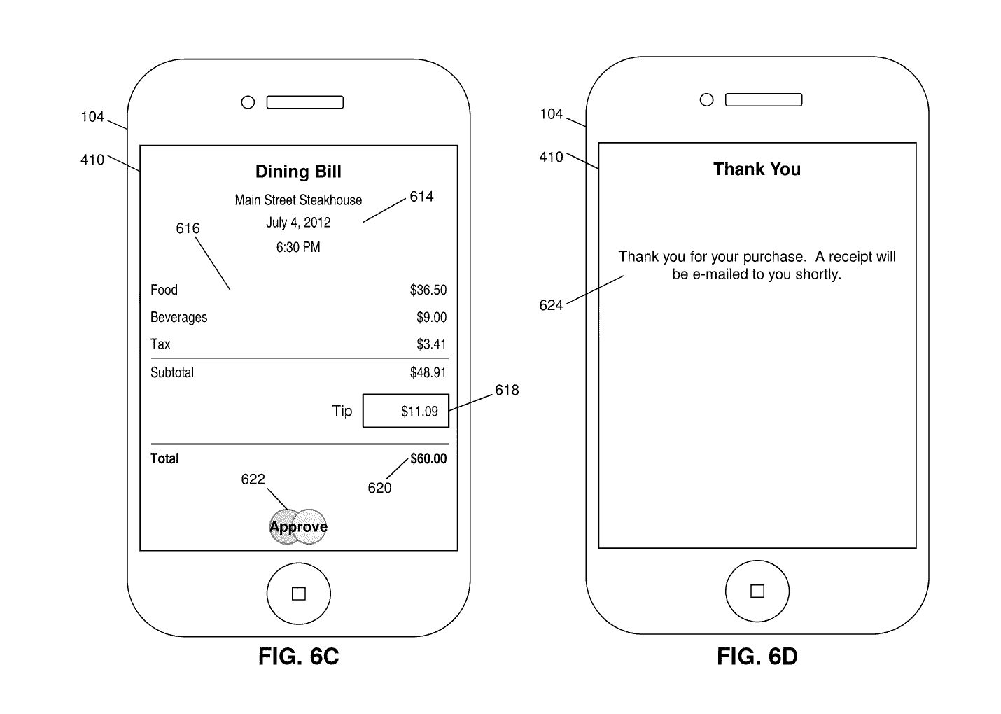

FIGS. 6A-6D illustrate an exemplary graphical user interface of the mobile device 104 for making a reservation including payment information and approving a transaction for a financial transaction using previously submitted payment information. As noted above, the reservation process can be done on a different device, such as a desktop computer having a different interface, and so the mobile device 104 should be understood to encompass any device capable of carrying out these operations.

The display unit 410 of the mobile device 104 may display, as illustrated in FIG. 6A, an application for making a reservation. The interface for making a reservation may include a merchant selection 602, a date selection 604, a time selection 606, and a payment selection 608. The merchant selection 602 may indicate a merchant for which the reservation is to be made. Although the merchant selection 602 is illustrated as a drop-down menu, it will be apparent to persons having skill in the relevant art that the merchant selection 602 and other selections illustrated in FIG. 6A may be implemented in additional formats, such as text boxes, radio buttons, lists, etc.

The date selection 604 may indicate the date for which the reservation is to be fulfilled. In some embodiments, the mobile device 104 may communicate with an external server (e.g., the reservation server 114) to identify only those dates for which a reservation can be made such that the date selection 604 only allow for selection of those valid dates. The time selection 606 may indicate the time for which the reservation is to be fulfilled. In some embodiments, the mobile device 104 may only display those times for which a reservation may be valid. It will be apparent to persons having skill in the relevant art that the time selection 606 may be optional (e.g., such as for a hotel reservation).

The payment selection 608 may indicate a payment method to be used for a financial transaction to be processed corresponding to the reservation. In some embodiments, the consumer 102 may select a stored payment method (e.g., payment card, checking account, gift card, etc.) from a list of stored payment methods to use to pay for the transaction. In other embodiments, the consumer 102 may manually enter payment information for each reservation for security reasons. In some embodiments, the payment selection 608 may include a button for inputting new payment information for selection.

Once the consumer 102 has selected the relevant reservation information, the consumer may input (e.g., via the input unit 402) authentication information in the authentication field 610. The authentication information can be different for different situations. It might only be a name of a person, involve conveyance of information known only to the customer (e.g., a PIN), or even biometrics, depending on the perceived required level of authentication. As illustrated in FIG. 6A, the authentication information may include a personal identification number (PIN), such as one associated with the payment card selected in the payment selection 608, or other information that may be suitable to authenticate the consumer 102, such as a password. Other methods for authenticating the consumer 102 will be apparent to persons having skill in the relevant art, such as using a microphone for voice recognition, a camera for facial recognition, or a touch display for fingerprint recognition. The consumer 102 may then interact with a button 612 to submit (e.g., via the transmitting unit 404) the reservation information (e.g., to the reservation server 114).

Once submitted, the display unit 410 of the mobile device 104 may display, as illustrated in FIG. 6B, a confirmation screen including a confirmation message 612 indicating that the reservation has been made. The confirmation screen may also include reservation information, such as the merchant selection 602, the time and date selections 606 and 604, and the payment information 608. In some embodiments, the reservation information may be received by the mobile device 104 in other or additional formats, such as an electronic mail or short message service (SMS) message.

Once the consumer 102 has fulfilled the reservation, the mobile device 104 may receive transaction information for a subsequent financial transaction, which may be displayed by the display unit 410 as illustrated in FIG. 6C. The displayed transaction information may include reservation information 614. The reservation information 614 may be information related to the reservation for correlating the transaction with the original reservation, such as the merchant identifier 506 and the expected time and/or date 510. The transaction information also may include a bill 616, which my detail the transaction for review by the consumer 102. In the example illustrated in FIG. 6C, the bill 616 includes food amount, beverage amount, tax amount, and a subtotal amount. Here, the exemplary embodiment is a mobile device of the consumer, which adds a level of security and authentication, but could be a terminal provided at the merchant site in certain embodiments.

The display unit 410 may also display a tip field 618, where the consumer 102 may input an additional amount to be included and approved in the transaction, such as a tip or gratuity. It will be apparent to persons having skill in the relevant art that the tip field 618 may be optional. The display may also include the transaction amount 620, which may include the total amount displayed in the bill 616 in addition to the amount input into the tip field 620. The mobile device 104 may also display an approval button 622. The consumer 102 may interact with the approval button 622, which may transmit to the financial transaction processor (e.g., the processing server 106) of the approval of the transaction.

As illustrated in FIG. 6D, once the transaction has been approved, the display unit 410 of the mobile device 104 may display a confirmation message 624. As illustrated, the confirmation message 624 may indicate that the purchase has been processed and that a receipt may be provided, such as by SMS message, by display with the confirmation message 624, by e-mail, etc. Other information, such as the transaction amount processed, may be displayed as will be apparent to persons having skill in the relevant art.

### Method for Processing a Reservation Including Payment Information

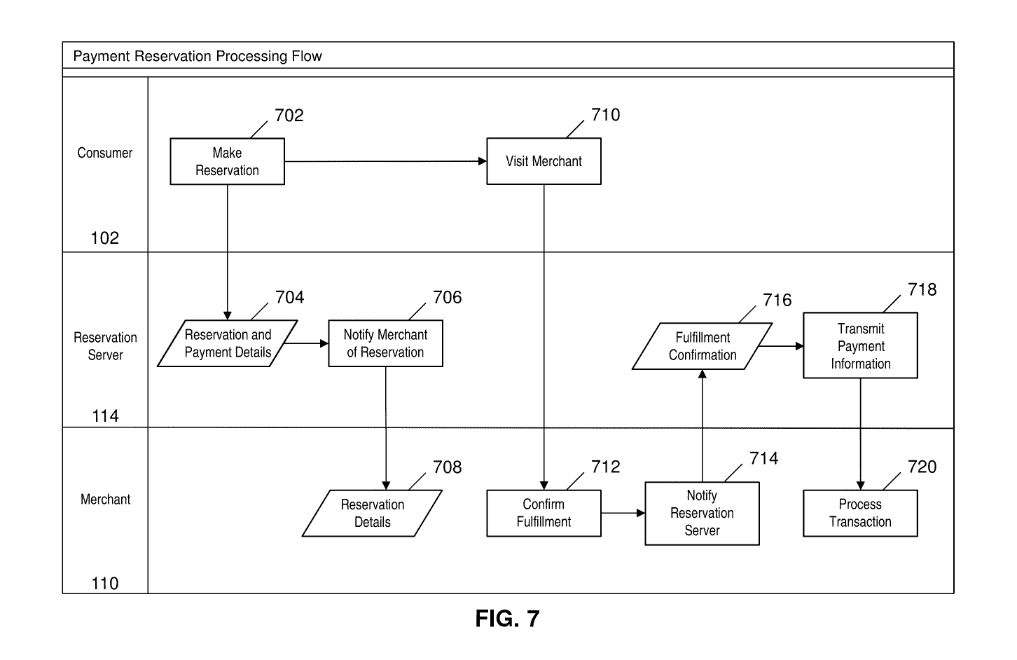

FIG. 7 is a flow diagram illustrating a method for processing a reservation for a financial transaction to be processed that includes payment information for the financial transaction.

In step 702, the consumer 102 may (e.g., using the mobile device 104) make a reservation by submitting reservation and payment details. In step 704, the reservation server 114 may receive and store (e.g., in the reservation database 116) the reservation and payment details. The reservation and payment details may include at least the consumer identifier 504, the merchant identifier 506, the payment information 508, and the expected date and/or time 510. In step 706, the reservation server 114 may notify the merchant 110 corresponding to the merchant identifier 506 of the reservation. The merchant 110 may receive, in step 708, the notification including reservation details, which may include at least the consumer identifier 504 and the expected date and/or time 510. In an exemplary embodiment, the merchant 110 does not receive the payment information 508.

In step 710, the consumer 102 may visit the merchant 110 at or near the expected date and/or time 510. In step 712, the merchant 110 may confirm the fulfillment of the reservation by the consumer 102. The merchant 110 may confirm the fulfillment by methods that will be apparent to persons having skill in the relevant art, such as confirming the name, e-mail address, or other information provided by the consumer 102 as matching the reservation details provided by the reservation server 114. In step 714, the merchant 110 may notify the reservation server 114 that the reservation has been fulfilled. In one embodiment, the merchant 110 may not notify the reservation server 114 until the corresponding financial transaction is ready to be processed.

In step 716 the reservation server 114 may receive confirmation of the fulfillment of the reservation, which may include at least the consumer identifier 506 for identifying the corresponding reservation dataset 502. In some embodiments, the reservation server 114 may receive confirmation of the fulfillment of the reservation from the consumer 102 (e.g., using the mobile device 104) directly. In one embodiment, the mobile device 104 may identify and transmit its geographic location to the reservation server 114, which may identify if it is proximal to a geographic location associated with the merchant 110 in the corresponding reservation dataset 502. In another embodiment, the mobile device 104 may read a machine readable code (e.g., an optical code, such as a QR code) encoded with data which may indicate to the reservation server 114 that the consumer 102 is at the location of the merchant 110 at the expected date and/or time 510.

In step 718, the reservation server 114 may transmit the received and stored payment information 508 to the merchant 110. The merchant 110 may then use the received payment information 508 to process the financial transaction, in step 720. In some embodiments, the merchant 110 may transmit transaction details to the reservation server 114 or a financial transaction processing agency for initiating of the financial transaction such that the merchant 110 will not be in possession of the payment information 508 at any point in time.

### Method for Processing a Reserved Financial Transaction

FIGS. 8A and 8B illustrate a flow diagram for a method for processing a reserved financial transaction using stored payment information.

In step 802, the consumer 102 may (e.g., using the mobile device 104) make a reservation for a financial transaction to be processed. In step 804, the processing server 106 (e.g., acting as or receiving from the reservation server 114) may receive the reservation and payment details, which may be stored in the transaction database 108. The reservation and payment details may include at least the consumer identifier 504, the merchant identifier 506, the payment information 508, and the expected date and/or time 510 for the reservation. In step 806, the processing server 106 may forward the necessary reservation details to the merchant 110 that corresponds to the merchant identifier 506. The reservation details may include at least the consumer identifier 504 and the expected date and/or time 510.

In step 808, the consumer 102 may fulfill the reservation. In one embodiment, fulfillment of the reservation may include the consumer 102 authenticating themselves as the consumer in the corresponding reservation, by conveying information known only to the customer 102 and the merchant 110 (e.g., the name used in the reservation and its time, a PIN or biometrics, including the customer's image being conveyed to the merchant 110, or nearly any other suitable method. In another embodiment, the consumer 102 may fulfill the reservation through the processing server 106. In a further embodiment, the mobile device 104 may identify and transmit its geographic location to the processing server 106, which may identify if it is proximal to a geographic location associated with the merchant 110 in the corresponding reservation dataset 502. In another embodiment, the mobile device 104 may read a machine readable code (e.g., an optical code, such as a QR code) encoded with data which may indicate to the processing server that the consumer 102 is at the location of the merchant 110 at the expected date and/or time 510.

In step 810, the merchant 110 may provide goods or services to the consumer 102 (e.g., by serving a meal to the consumer 102 for a meal reservation, delivery of a car in a car rental reservation, or access to a room in a hotel room reservation). It will be apparent to persons having skill in the relevant art that this step may be performed later in the process (e.g., after the financial transaction has been conducted). In step 812, the merchant 110 may submit an authorization request for a financial transaction to the processing server 106. The authorization request may include at least the consumer identifier 504, the merchant identifier 506, and a transaction amount. In step 816, the processing server 106 may request approval for the transaction from the consumer 102 (e.g., using the mobile device 104).

In step 818, the mobile device 104 of the consumer 102 may display (e.g., as illustrated in FIG. 6C) an approval request for the financial transaction. In one embodiment, the display of the approval request may include at least the transaction amount. In step 820, the consumer 102 may approve the transaction using the mobile device 104. In one embodiment, the consumer 102 may indicate an additional amount over the transaction amount for which the transaction may be approved, such as to account for a tip, gratuity, etc. In step 822, the processing server 106 may receive the approval from the consumer 102, including any additional information, such as the indicated additional amount. It will be apparent to persons having skill in the relevant art that steps 816 to 822 may be optional (e.g., the processing server 106 may not be required to obtain approval for a transaction from the consumer 102).

In step 824, the processing server 106 may process the financial transaction by methods that will be apparent to persons having skill in the relevant art, such as the traditional four party processing system. In embodiments where the transaction was approved including an additional amount, the transaction may be processed for an amount equal to the transaction amount plus the additional amount. In step 826, the processing server 106 may transmit an authorization response for the financial transaction (e.g., indicating that the transaction has been approved or denied) to the merchant 110, who may receive the response in step 828. In step 830, the merchant 110 may finalize the transaction (e.g., by providing the consumer 102 with goods or services, indicating to the consumer 102 that they have paid and are free to leave, etc.).

In step 832 the processing server 106 may transmit a receipt for the transaction to the consumer 102. In one embodiment, the receipt may be transmitted to the mobile device 104 of the consumer 102. In a further embodiment, it may be transmitted via electronic mail, SMS message, or to an application program (e.g., as illustrated in FIGS. 6A-6D) executed on the mobile device 104. In 834, the consumer 102 may receive the receipt, which may be displayed on the mobile device 104.

### Computer System Architecture

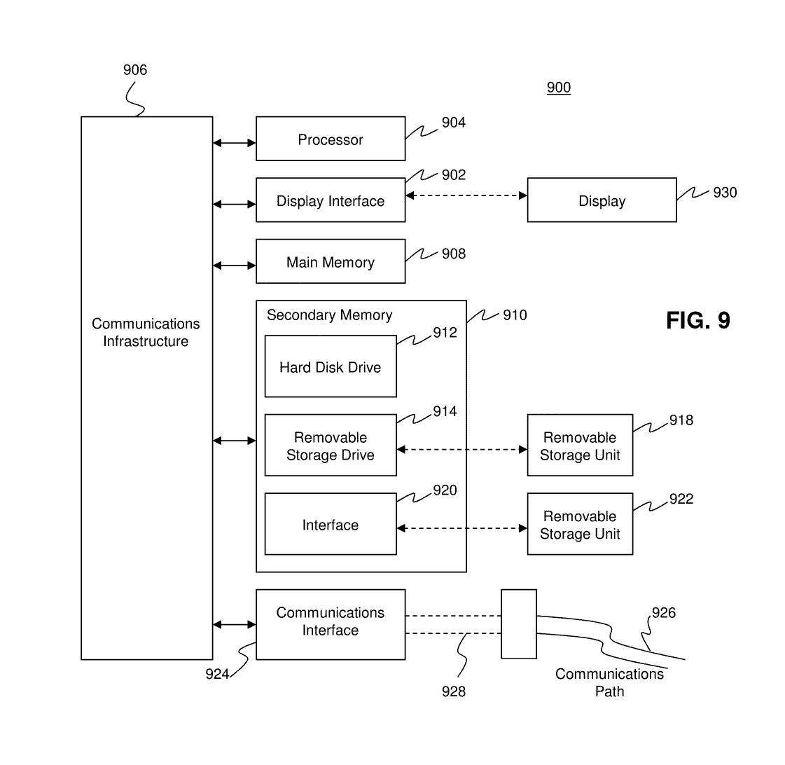

FIG. 9 illustrates a computer system 900 in which embodiments of the present disclosure, or portions thereof, may be implemented as computer-readable code. For example, the mobile device 104, the processing server 106, the merchant 110, and the reservation server 114 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 7, 8A, 8B, 10, 11, and 12.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device. The processor device 904 may be connected to a communication infrastructure 906, such as a bus, message queue, network (e.g., the network 108), multi-core message-passing scheme, etc. The computer system 800 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive, the removable storage unit 918 may be a floppy disk. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

Computer program medium and computer usable medium may refer to memories, such as the main memory 908 and secondary memory 910, which may be memory semiconductors (e.g. DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 7, 8A, 8B, 10, 11, and 12, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

### Exemplary Method for Processing a Reservation

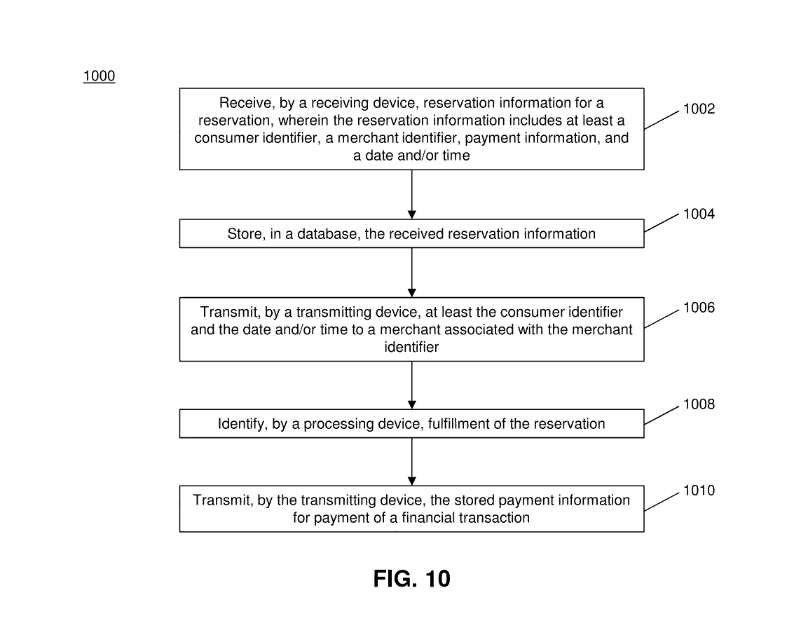

FIG. 10 illustrates a method 1000 for processing a reservation including payment information for a future financial transaction. In step 1002, reservation information for a reservation may be received by a receiving device (e.g., the receiving unit 302), wherein the reservation information includes at least a consumer identifier (e.g., the consumer identifier 504), a merchant identifier (e.g., the merchant identifier 506), payment information (e.g., the payment information 508), and a date and/or time (e.g., the date and/or time 510). In one embodiment, the payment information may include at least a payment card associated with a consumer (e.g., the consumer 102). In a further embodiment, the consumer 102 may be associated with the consumer identifier 504.

In step 1004, the received reservation information may be stored in a database (e.g., the reservation database 116). In step 1006, at least the consumer identifier 504 and the date and/or time 510 may be transmitted, by a transmitting device (e.g., the transmitting unit 306) to a merchant (e.g., the merchant 110) associated with the merchant identifier 506. In one embodiment, the payment information 508 is not transmitted to the merchant 110 during step 1004.

In step 1008, fulfillment of the reservation may be identified by a processing device (e.g., the processing unit 304). In some embodiments, the identification may be performed temporally proximal to the date and/or time 510. In one embodiment, identifying the fulfillment of the reservation may include receiving, by the receiving unit 302, an indication of confirmation of the reservation from the merchant 110 associated with the merchant identifier 506. In another embodiment, identifying the fulfillment of the reservation may include receiving, by the receiving unit 302, a confirmation message from a mobile communication device (e.g., the mobile device 104) associated with the consumer 102 associated with the consumer identifier 504.

In yet another embodiment, identifying the fulfillment of the reservation may include identifying a geographic location associated with the merchant identifier 506, receiving a geographic location of the consumer 102 associated with the consumer identifier 504, and identifying if the geographic location of the consumer corresponds to the geographic location associated with the merchant identifier 506. In a further embodiment, identifying the geographic location of the consumer 102 may include receiving a geographic location from a mobile communication device (e.g., the mobile device 104) associated with the consumer 102. In an alternative further embodiment, identifying that the geographic location of the consumer 102 corresponds to the geographic location associated with the merchant identifier 506 may include identifying if the geographic location of the consumer 102 is proximal to the geographic location associated with the merchant identifier.

In step 1010, the stored payment information 508 may be transmitted, by the transmitting unit 306, for payment of a financial transaction. In one embodiment, the payment information 508 may be transmitted to the merchant 110. In another embodiment, the payment information 508 may be transmitted to a financial transaction processing agency (e.g., the processing server 106)

### Exemplary Method for Processing a Financial Transaction

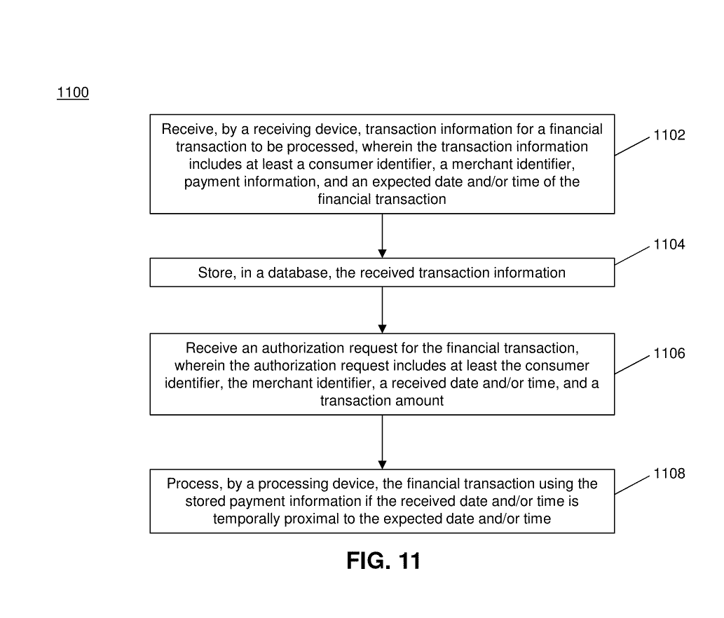

FIG. 11 illustrates a method 1100 for processing a financial transaction for a reservation using previously stored payment information.

In step 1102, transaction information for a financial transaction to be processed may be received by a receiving device (e.g., the receiving unit 202), wherein the transaction information includes at least a consumer identifier (e.g., the consumer identifier 504), a merchant identifier (e.g., the merchant identifier 504), payment information (e.g., the payment information 508), and an expected date and/or time (e.g., the expected date and/or time 510). In one embodiment, the merchant identifier 504 may be a geographic location. In some embodiments, the payment information 508 may include at least a payment card associated with a consumer (e.g., the consumer 102) associated with the consumer identifier 504.

In step 1104, the received transaction information may be stored in a database (e.g., the transaction database 108). In step 1106, an authorization request may be received, wherein the authorization request includes at least the consumer identifier 504, the merchant identifier 506, a received date and/or time, and a transaction amount. In one embodiment, the authorization request may be formatted in the International Organization for Standardization ISO 8583 standard. In step 1106, the financial transaction may be processed, by a processing device (e.g., the processing unit 204), using the stored payment information 508 if the received date and/or time is temporally proximal to the expected date and/or time 510.

In one embodiment, the method 1100 may further include identifying a geographic location associated with the merchant identifier 506, receiving a geographic location of a consumer (e.g., the consumer 102) associated with the consumer identifier 504, and identifying if the geographic location of the consumer 102 corresponds to the geographic location associated with the merchant identifier 506. In one embodiment, receiving a geographic location of the consumer 102 may include receiving a geographic location of a mobile communication device (e.g., the mobile device 104) associated with the consumer 102. In another embodiment, identifying if the geographic location of the consumer 102 corresponds to the geographic location associated with the merchant identifier 506 may include identifying if the geographic location of the consumer 102 is proximal to the geographic location associated with the merchant identifier 506.

### Exemplary Method for Approving a Financial Transaction

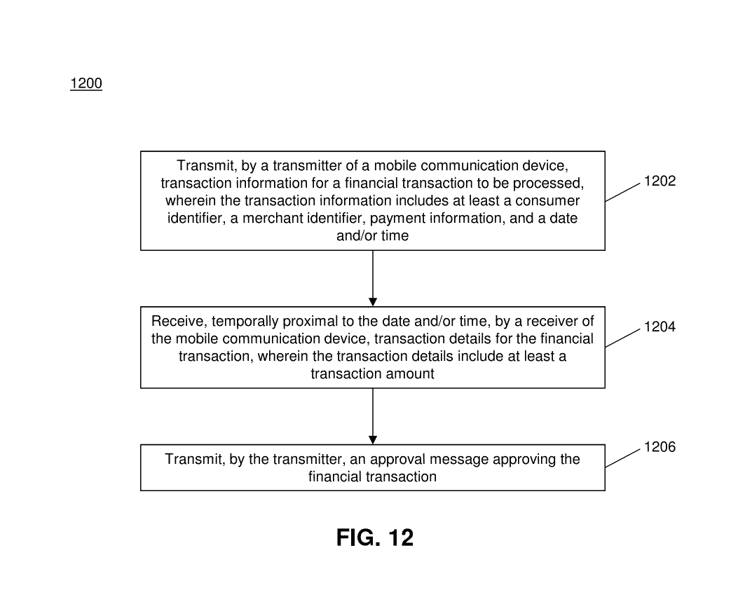

FIG. 12 illustrates a method 1200 for approving a financial transaction received temporally proximal to a reserved date and/or time.

In step 1202, transaction information for a financial transaction to be processed may be transmitted, by a transmitter (e.g., the transmitting unit 404) of a mobile communication device (e.g., the mobile device 104), wherein the transaction information includes at least a consumer identifier (e.g., the consumer identifier 504), a merchant identifier (e.g., the merchant identifier 504), payment information (e.g., the payment information 508), and a date and/or time (e.g., the date and/or time 510). In one embodiment, the mobile device 104 may be at least one of a mobile phone, a smart phone, and a tablet computer, but as mentioned elsewhere, nearly any device capable of carrying out the communications and processes could be used, and in fact different devices could be used for different parts of the method. In one embodiment, the payment information 508 may include at least a payment card associated with a consumer (e.g., the consumer 102). In a further embodiment the consumer 102 may be associated with at least one of the mobile device 104 and the consumer identifier 504.

In step 1204, transaction details for the financial transaction may be received, temporally proximal to the date and/or time 510, by a receiver (e.g., the receiving unit 406) of the mobile device 104, wherein the transaction details include at least a transaction amount. In step 1206, an approval message approving the financial transaction may be transmitted by the transmitting unit 404. In some embodiments, the approval message may include an approved tip amount. In some embodiments, the method 1200 may further include identifying, by a processor (e.g., the processing unit 408) of the mobile device 104, a geographic location of the mobile device 104 and transmitting, by the transmitting unit 404, the geographic location of the mobile device 104.

In one embodiment, identifying the geographic location of the mobile device 104 may utilize at least one of: a global positioning system (GPS), a mobile communication network, a wireless network, WiFi, and a cellular network. In another embodiment, identifying the geographic location of the mobile device 104 may include reading, by a reader of the mobile device 104, a machine-readable code encoded with the geographic location. In a further embodiment, the machine readable-code may be displayed at the geographic location. In another further embodiment, the machine-readable code may be a bar code. In an even further embodiment, the bar code may be a QR code.

Techniques consistent with the present disclosure provide, among other features, systems and methods for processing reservations including payment information and approving and processing corresponding financial transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

1. A method of processing a reservation, comprising:
receiving, by a receiving device, reservation information for a reservation, wherein the reservation information includes at least a consumer identifier, a merchant identifier, payment information, and a date and/or time;
storing, in a database, the received reservation information;
transmitting, by a transmitting device, at least the consumer identifier and the date and/or time to a merchant associated with the merchant identifier;
identifying, by a processing device, fulfillment of the reservation; and
transmitting, by the transmitting device, the stored payment information for payment of a financial transaction corresponding to the received reservation information and involving the merchant associated with the merchant identifier.

2. The method of claim 1, wherein identifying fulfillment of the reservation comprises:
identifying, by the processing device, a geographic location associated with the merchant identifier;
receiving, by the receiving device, a geographic location of a consumer associated with the consumer identifier; and
identifying, by the processing device, if the geographic location of the consumer corresponds to the geographic location associated with the merchant identifier.

3. The method of claim 2, wherein identifying a geographic location of a consumer includes receiving a geographic location of a mobile communication device associated with the consumer.

4. The method of claim 2, wherein identifying if the geographic location of the consumer corresponds to the geographic location associated with the merchant identifier includes identifying if the geographic location of the consumer is proximal to the geographic location associated with the merchant identifier.

5. The method of claim 1, wherein identifying fulfillment of the reservation comprises:
receiving, by the receiving device, an indication of confirmation of the reservation from the merchant associated with the merchant identifier.

6. The method of claim 1, wherein identifying fulfillment of the reservation comprises:
receiving, by the receiving device, a confirmation message from a mobile communication device associated with a consumer associated with the consumer identifier.

7. The method of claim 1, wherein the identifying step is performed temporally proximal to the date and/or time.

8. The method of claim 1, wherein the payment information includes at least a payment card associated with a consumer.

9. A method of processing a financial transaction, comprising:
receiving, by a receiving device, transaction information for a financial transaction to be processed, wherein the transaction information includes at least a consumer identifier, a merchant identifier, payment information, and an expected date and/or time of the financial transaction;
storing, in a database, the received transaction information;
receiving, an authorization request for the financial transaction, wherein the authorization request includes at least the consumer identifier, the merchant identifier, a received date and/or time, and a transaction amount; and
processing, by a processing device, the financial transaction using the stored payment information if the received date and/or time is temporally proximal to the expected date and/or time.

10. The method of claim 9, further comprising:
identifying, by the processing device, a geographic location associated with the merchant identifier;
receiving, by the receiving device, a geographic location of a consumer associated with the consumer identifier; and
identifying, by the processing device, if the geographic location of the consumer corresponds to the geographic location associated with the merchant identifier.

11. The method of claim 9, wherein the merchant identifier is a geographic location.

12. The method of claim 9, wherein the payment information includes at least a payment card associated with a consumer.

13. The method of claim 10, wherein receiving a geographic location of a consumer includes receiving a geographic location of a mobile communication device associated with the consumer.

14. The method of claim 10, wherein identifying if the geographic location of the consumer corresponds to the geographic location associated with the merchant identifier includes identifying if the geographic location of the consumer is proximal to the geographic location associated with the merchant identifier.

15. The method of claim 9, wherein the authorization request is formatted in the ISO 8583 standard.

16. A method of approving a financial transaction, comprising:
transmitting, by a transmitter of a mobile communication device, transaction information for a financial transaction to be processed, wherein the transaction information includes at least a consumer identifier, a merchant identifier, payment information, and a date and/or time;
receiving, temporally proximal to the date and/or time, by a receiver of the mobile communication device, transaction details for the financial transaction, wherein the transaction details includes at least a transaction amount; and
transmitting, by the transmitter, an approval message approving the financial transaction.

17. The method of claim 16, further comprising:
identifying, by a processor of the mobile communication device, a geographic location of the mobile communication device; and
transmitting, by the transmitter of the mobile communication device, the geographic location of the mobile communication device.

18. The method of claim 16, wherein the mobile communication device is at least one of: a mobile phone, a smart phone, and a tablet computer.

19. The method of claim 16, wherein the payment information includes at least a payment card associated with a consumer.

20. The method of claim 17, wherein identifying the geographic location of the mobile communication device utilizes at least one of: a global positioning system (GPS), a mobile communication network, a wireless network, WiFi, and a cellular network.

21. The method of claim 17, wherein identifying the geographic location of the mobile communication device includes reading, by a reader of the mobile communication device, a machine-readable code encoded with the geographic location.

22. The method of claim 21, wherein the machine-readable code is an optical code.

23. The method of claim 22, wherein the optical code is a QR code.

24. The method of claim 21, wherein the machine-readable code is displayed at the geographic location.

25. The method of claim 16, wherein the approval message includes an approved tip amount.

26. A system for processing a reservation, comprising:
a data receiving device configured to receive data including reservation information for a reservation, wherein the reservation information includes at least a consumer identifier, a merchant identifier, payment information, and a date and/or time;
a database configured to store the received reservation information;
a data transmitting device configured to transmit data including at least the consumer identifier and the date and/or time to a merchant associated with the merchant identifier; and
a processor configured to identify fulfillment of the reservation, and cause the transmitter to transmit the stored payment information for payment of a financial transaction corresponding to the received reservation information and involving the merchant associated with the merchant identifier.

27. The system of claim 26, wherein
the receiver is further configured to receive a geographic location of a consumer associated with the consumer identifier; and
the processor is further configured to
identify a geographic location associated with the merchant identifier, and
identify if the geographic location of the consumer corresponds to the geographic location associated with the merchant identifier.

28. The system of claim 27, wherein identifying a geographic location of a consumer includes receiving a geographic location of a mobile communication device associated with the consumer.

29. The system of claim 27, wherein identifying if the geographic location of the consumer corresponds to the geographic location associated with the merchant identifier includes identifying if the geographic location of the consumer is proximal to the geographic location associated with the merchant identifier.

30. The system of claim 26, wherein identifying fulfillment of the reservation comprises:
receiving, by the receiver, an indication of confirmation of the reservation from the merchant associated with the merchant identifier.

31. The system of claim 26, wherein identifying fulfillment of the reservation comprises:
receiving, by the receiver, a confirmation message from a mobile communication device associated with a consumer associated with the consumer identifier.

32. The system of claim 26, wherein the processor is further configured to identify fulfillment of the reservation temporally proximal to the date and/or time.

33. The system of claim 26, wherein the payment information includes at least a payment card associated with a consumer.

34. A system for processing a financial transaction, comprising:
a receiver configured to receive
transaction information for a financial transaction to be processed, wherein the transaction information includes at least a consumer identifier, a merchant identifier, payment information, and an expected date and/or time for the financial transaction, and
an authorization request for the financial transaction, wherein the authorization request includes at least the consumer identifier, the merchant identifier, a received date and/or time, and a transaction amount;
a database configured to store the received transaction information; and
a processor configured to process the financial transaction using the stored payment information if the received date and/or time is temporally proximal to the expected date and/or time.

35. The system of claim 34, wherein
the receiver is further configured to receive a geographic location of a consumer associated with the consumer identifier;
the processor is further configured to
identify a geographic location associated with the merchant identifier, and
identify if the geographic location of the consumer corresponds to the geographic location associated with the merchant identifier.

36. The system of claim 34, wherein the merchant identifier is a geographic location.

37. The system of claim 34, wherein the payment information includes at least a payment card associated with a consumer.

38. The system of claim 35, wherein receiving a geographic location of a consumer includes receiving a geographic location of a mobile communication device associated with the consumer.

39. The system of claim 35, wherein identifying if the geographic location of the consumer corresponds to the geographic location associated with the merchant identifier includes identifying if the geographic location of the consumer is proximal to the geographic location associated with the merchant identifier.

40. The system of claim 34, wherein the authorization request is formatted in the ISO 8583 standard.

41. A mobile communication device, comprising:
a transmitter configured to transmit transaction information for a financial transaction to be processed, wherein the transaction information includes at least a consumer identifier, a merchant identifier, payment information, and a date and/or time;
a receiver configured to receive, temporally proximal to the date and/or time, transaction details for the financial transaction, wherein the transaction details includes at least a transaction amount,
wherein the transmitter is further configured to transmit an approval message approving the financial transaction.

42. The mobile communication device of claim 41, further comprising a processor configured to identify the geographic location of the mobile communication device, and
wherein the transmitter is further configured to transmit the identified geographic location of the mobile communication device.

43. The mobile communication device of claim 41, wherein the payment information includes at least a payment card associated with a consumer.

44. The mobile communication device of claim 42, wherein identifying the geographic location of the mobile communication device utilizes at least one of: a global positioning system (GPS), a mobile communication network, a wireless network, WiFi, and a cellular network.

45. The mobile communication device of claim 42, further comprising:
a reader configured to read a machine-readable code encoded with the geographic location.

46. The mobile communication device of claim 45, wherein the machine-readable code is an optical code.

47. The mobile communication device of claim 46, wherein the bar code is a QR code.

48. The mobile communication device of claim 45, wherein the machine-readable code is displayed at the geographic location.

49. The mobile communication device of claim 41, wherein the approval message includes an approved tip amount.
